(19) United States
(12) Patent Application Publication
(10) Pub. No.: US 2024/0408664 A1
(43) Pub. Date: Dec. 12, 2024

(54) METHOD AND SYSTEM FOR PRODUCING A WIRE MESH MAT FROM INTERSECTING LONGITUDINAL WIRES AND TRANSVERSE WIRES

(71) Applicant: EVG ENTWICKLUNGS- U. VERWERTUNGS-GESELLSCHAFT M.B.H., Raaba (AT)

(72) Inventors: Robert TREMMEL, Graz (AT); Andreas BACI, Graz (AT)

(21) Appl. No.: 18/690,413

(22) PCT Filed: Sep. 9, 2022
(86) PCT No.: PCT/IB2022/058521

§ 371 Date: Mar. 8, 2024

(30) Foreign Application Priority Data
Sep. 10, 2021 (AT) A 50717/2021

(51) Int. Cl. B21F 27/10

(52) U.S. Cl. CPC B21F 27/10

(57) ABSTRACT

A method for producing a wire mesh mat that consists of intersecting longitudinal and transverse wires and to a mesh welding facility for welding a wire mesh mat from intersecting longitudinal and transverse wires, comprising a clocked supply device for a sheet of longitudinal wires in an X direction, a feed device for transverse wires that lie perpendicular to the longitudinal wires and to a welding portal for welding the wires at their intersections.

### FIELD

The invention relates to a method for producing a wire mesh mat from intersecting longitudinal wires and transverse wires as well as to a mesh welding system for welding a wire mesh mat from intersecting longitudinal wires and transverse wires with a clocked feed device for a set of longitudinal wires in an x direction, with a feed device for transverse wires lying perpendicular to the longitudinal wires and with a welding portal for welding the wires at their intersection points.

### BACKGROUND

The state of the art is the production of reinforcement mesh products with restrictions regarding product division, i.e., the variation of mesh width, mesh length within a wire mesh mat or between successively produced wire mesh mats. Until now, product division has been set on automated wire mesh welding systems and then produce a mat or a series by automatically taking longitudinal and transverse wires from a supply and welding them in the desired positions. Due to the increasing degree of individualization and the optimization of material usage, strength-and design-optimized end products will be required in the future. Free product forms (special products) have not yet been realized.

### SUMMARY

The aim is to create a method and a system that enables a fully flexible design of mesh mats. The solution should also be economical to provide.

The method according to the invention achieves this by comprising the steps:

(i) Feeding of a set of longitudinal wires along an x direction to a welding portal with welding units, wherein the longitudinal wires are moved and held parallel to one another in a fixed grid by releasable longitudinal wire gripper elements which can move along in the x direction,
(ii) Welding of at least one first longitudinal wire with a first transverse wire,
(iii) Releasing of the clamping of the at least one first longitudinal wire and moving of the non-welded longitudinal wires in the (−Y) direction, which is essentially perpendicular to the x direction, in order to adjust the grid of at least one longitudinal wire,
(iv) Welding of at least one second longitudinal wire to the first transverse wire,
(vii) Multiple, clocked feeding of the set of longitudinal wires in the X direction and simultaneous welding of all previously welded longitudinal wires with a second and further transverse wires.

In one embodiment of the invention, step (iv) is followed by and step (vii) is preceded by:

(v) Releasing of the clamping of the at least one second longitudinal wire and moving of the non-welded longitudinal wires in the (+Y) direction or in the (−Y) direction,
(vi) Welding of at least one third longitudinal wire to the first transverse wire. In one embodiment of the invention, step (i) comprises the substeps:
(i-a) Removing of a set of longitudinal wires, which are held ready in a fixed grid by longitudinal wire guide elements on a receiving table, by a longitudinal wire feed unit, which can be moved towards the receiving table in the (−X) direction and on which the longitudinal wires are clamped in longitudinal wire gripper elements depending on the required longitudinal wire distance,
(i-b) Moving of the longitudinal wire feed unit in (+X) direction together with the longitudinal wire coulter.

In a further step (viii), a wire mesh mat can be pulled out behind the welding portal with a pull-out beam movable in the x direction, which temporarily hooks or engages with a plurality of hook or gripper elements on one of the transverse wires of a wire mesh mat.

It is also conceivable that in step (viii) only those of a plurality of hook or gripper elements are brought into action which, according to the produced grid, lie on the wire mesh mat between two adjacent longitudinal wires.

The mesh welding system according to the invention achieves the objectives in that a receiving table is provided for receiving the set of longitudinal wires lying parallel to one another and with longitudinal wire guide elements in a fixed grid, and a longitudinal wire feed unit which can be moved back and forth cyclically in the X direction is arranged between the receiving table and the welding portal, which in turn has longitudinal wire gripper elements for the longitudinal wires, wherein the longitudinal wire feed unit also is movable in the Y direction and wherein the distance of the welding portal from the longitudinal wire guide elements of the receiving table is dimensioned at least such that a longitudinal wire located therein remains deformable in the elastic range at maximum deflection.

In one embodiment of the invention, a plurality of welding units are provided in the welding portal, in front of each of which a fixing unit for a longitudinal wire is arranged as viewed in the production direction X.

In a further variation, a plurality of welding units are provided in the welding portal, each of which has a transverse wire stop.

It is also conceivable that a pull-out beam movable in the X direction and extending essentially in the Y direction is arranged downstream of the welding portal in production direction X with a plurality of hook or gripper elements for transporting wire mesh mats, wherein the hook elements can be pivoted individually between two positions, in which the hook elements are located either outside the mesh plane or inside the mesh plane.

It is further provided that in one embodiment at least one guide plate is provided on the pull-out beam, which extends at a predetermined distance above the mesh plane and which has passages for the hook elements, through which the hook elements can be moved between the two positions.

### BRIEF DESCRIPTION OF THE DRAWINGS

The invention is explained in more detail below with reference to an exemplary embodiment shown in the drawings. Showing:

FIGS. 1 to 7 are schematic top views of a mesh welding system with successive method steps;

FIG. 8 is a perspective view of a single spot welding device;

FIG. 9 a perspective view of a part of a pull-out beam for wire mesh; and

FIG. 10 a schematic top view of a pull-out beam with a part of a wire mesh.

### DETAILED DESCRIPTION

The system consists of a receiving table 1 with a fixed grid R for a set of longitudinal bars or longitudinal wires LD. The longitudinal wires LD are removed by a power-operated longitudinal wire feed unit 3, adjusted transversely depending on the product division and transferred to the welding carriage 8 with fixing units 6, which can be moved variably transversely in the Y direction, and welded.

The method for the fully automatic production of a reinforcement mesh mat consists of the steps of welding one or more transverse wires QD to one or more spaced-apart longitudinal wires LD in a variable grid, wherein one or more longitudinal wires LD are welded to the same transverse wire QD in one welding cycle.

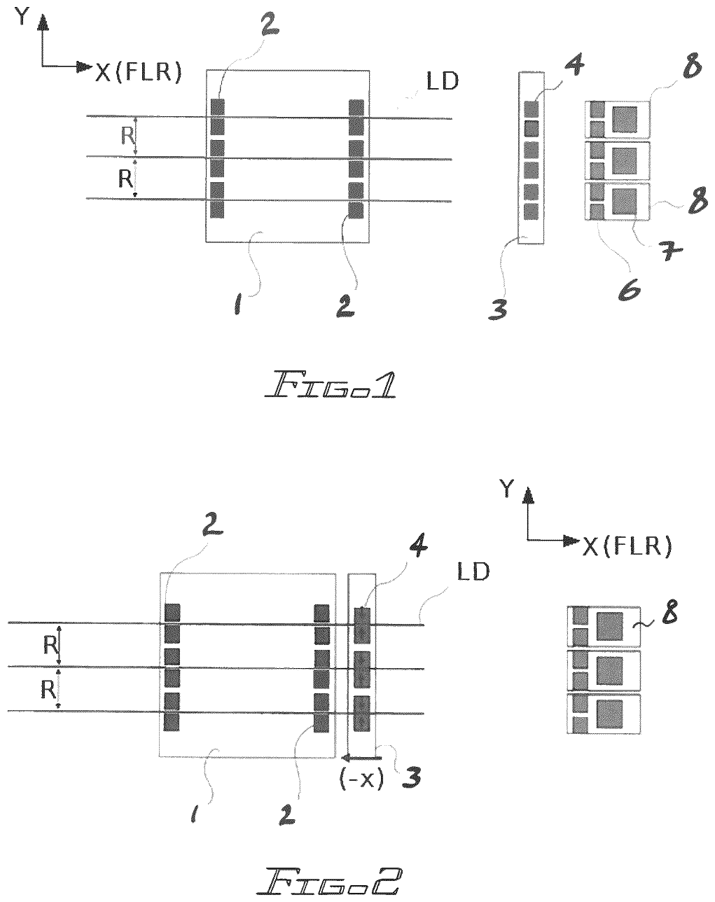

FIG. 1 shows the basic position of the device according to the invention and the starting point of the method. As an example, a set of three longitudinal wires LD is arranged along the x direction in longitudinal wire guide elements 2 on a receiving table 1. Many more longitudinal wires LD, e.g., twenty, can be used in practice. The longitudinal wires LD are preferably provided by a straightening machine (not shown) and lie parallel to each other in a fixed grid R. Grid R refers to the distances between the longitudinal wires LD.

The set of longitudinal wires LD also defines the plane in the X and Y directions which they cover and in which the wire mesh mat to be produced will extend. This is therefore also the mat or mesh plane.

Continuing in the (+X) direction, a longitudinal wire feed unit 3 is arranged, on which longitudinal wire gripper elements 4 are located, and which can move back and forth in the X direction between the receiving table 1 and a welding portal 5 consisting of a plurality of welding carriages 8. Longitudinal wire gripper elements 4 are positioned on the longitudinal wire feed unit 3 for each longitudinal wire LD and can be controlled individually.

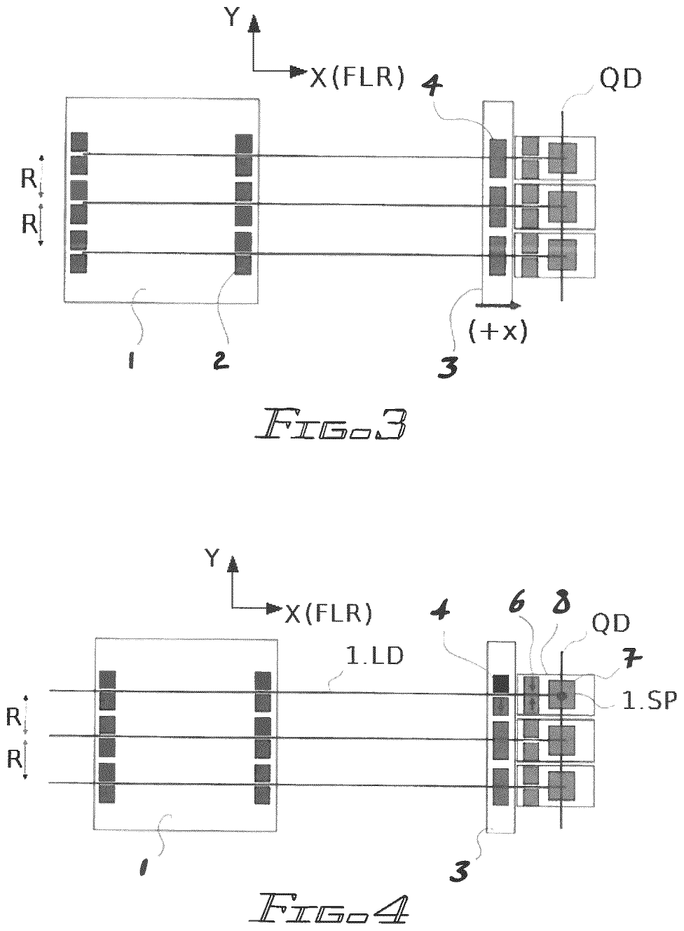

According to FIG. 2, the longitudinal wire feed unit 3 moves against the flow direction ((−X) direction) into the receiving position, depending on the required longitudinal wire distance. There, the longitudinal wires LD are force-fitted by temporary clamping in longitudinal wire gripper elements 4. The grid R is retained and specifies the exact position of at least one first longitudinal wire in the Y direction.

The variability of the manufactured wire mesh mats also concerns the selectable and changeable length of possible protrusions of the longitudinal rods or longitudinal wires LD.

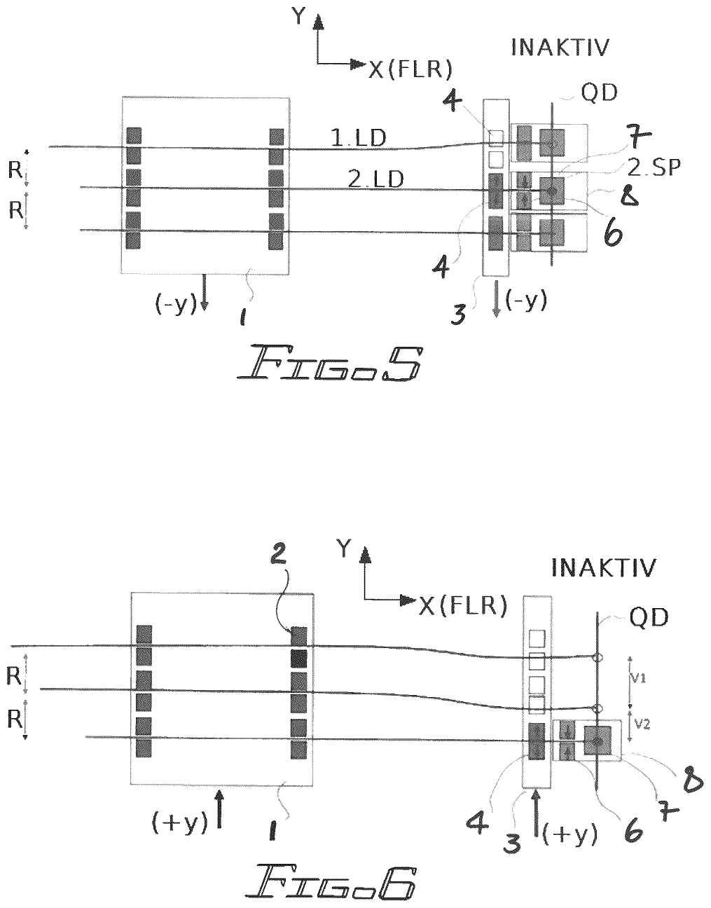

As shown in FIG. 3, the set of longitudinal wires LD is moved into the welding position by moving the longitudinal wire feed unit 3 in the X direction, depending on the desired end product. The longitudinal wires LD reach their respective welding unit 7 in a welding carriage 8 in the welding portal 5. Similarly, a transverse wire QD is inserted into the welding line essentially perpendicular to the longitudinal wires LD and positioned precisely.

As shown in FIG. 4, the longitudinal wire gripper element 4 of a first longitudinal wire LD is now opened simultaneously or in succession, and a fixing unit 6, or centering unit or transfer unit, acting in each case for a longitudinal wire LD is closed before each welding unit 7. The longitudinal wire LD is thereby fixed in the Y direction to the transversely movable (in Y direction) welding carriage 8. The first longitudinal wire LD is then welded to the transverse wire QD at the welding point SP by the welding unit 7.

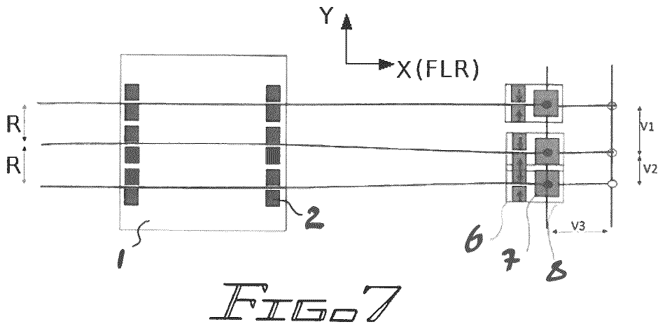

Then, as shown in FIG. 5, a second longitudinal wire LD with a division that differs from the grid R is welded to the transverse wire QD. For this purpose, the longitudinal wire feed unit 3 is adjusted in translation transverse to the direction of flow (X direction), namely in the (−Y) direction. The longitudinal wire gripper element 4 of the first longitudinal wire LD no longer influences the product indirectly, as it is set to “inactive”, i.c., it is released or moved away. At the same time, the receiving table 1 is moved in the same direction (−Y) in the same example.

This is just one example. The retraction of all corresponding elements in the (+Y) direction depending on the desired division can be carried out in the same way according to the invention.

Due to the free length, i.c., the distance between the receiving table 1 and the welding line in the welding portal 5, which is sufficiently large, the unavoidable deformation of the first longitudinal wire LD takes place in the elastic range. The reaction forces are negligible in terms of their influence on the processing of the end product. In one embodiment, a longitudinal wire LD is additionally clamped with an adjacent welding rod if the reaction forces are no longer in the negligible range.

The free length depends on the wire diameter. In a machine, according to the invention, it must be set according to the largest required length with regard to the possible wire diameters to be processed. The mechanics for moving the longitudinal wire feed unit 3 must be designed accordingly.

The second longitudinal wire LD is then centered on the fixing unit 6, held in place and welded to the transverse wire QD (similar to welding in FIG. 4). Adjusting the receiving table 1 also ensures precise welding, as the second longitudinal wire LD to be welded is now guided to its welding point SP without tension.

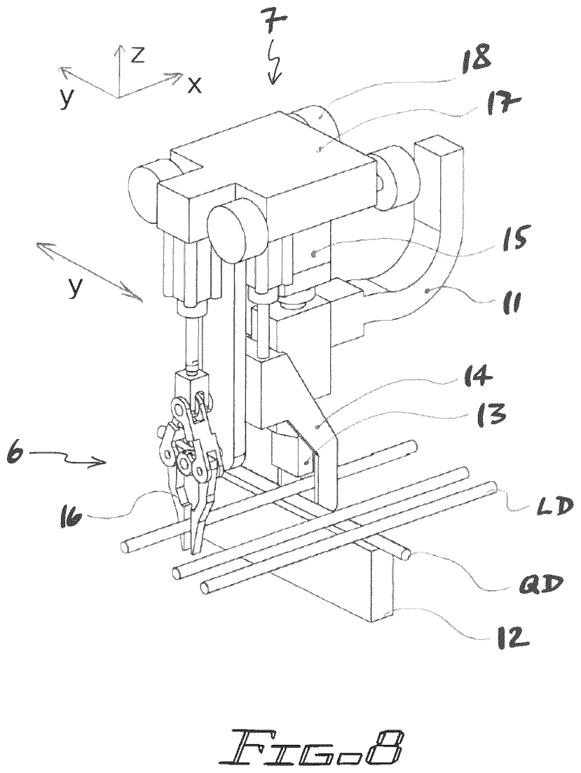

In FIG. 6, the remaining longitudinal wire(s) LD is/are moved back in the (+Y) direction (alternatively in the (−Y) direction) in order to then be welded to the transverse wire QD. For this purpose, the longitudinal wire gripper element 4 of the second longitudinal wire LD is also deactivated and both the longitudinal wire feed unit 3 and the receiving tables 1 are moved back in the (+Y) direction. After reaching the target position, the third longitudinal wire LD is centered and welded as before. It goes without saying that all elements of welding portal 5 that may remain in the travel path are deleted or deactivated in the same way. The variable division achieved (the ratio of the two distances VI and V2) between the previously welded three longitudinal wires LD is now not equal to one and also deviates from the grid R on the receiving table 1.

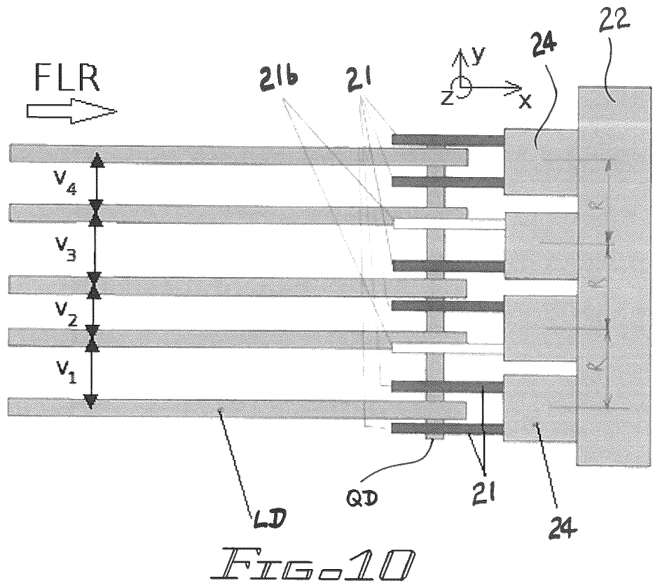

As can be seen in FIG. 7, the finished welded transverse wire QD in this example is preferably taken by a mesh pull-out (FIGS. 9 and 10), thereby moving the resulting wire mesh mat in the X direction over a predetermined length V3. A second transverse wire QD is added and welded with the variable division V3 generated by the previous steps. The longitudinal wires LD are welded to the second transverse wire QD either simultaneously or one after the other. The longitudinal wire feed unit 3 (not shown in FIG. 7) is inactive. All longitudinal wires LD are centered by their respective fixing units 6 for precise welding. As before, the welding units 7 can be moved freely in the Y direction and are already arranged according to the previously created division.

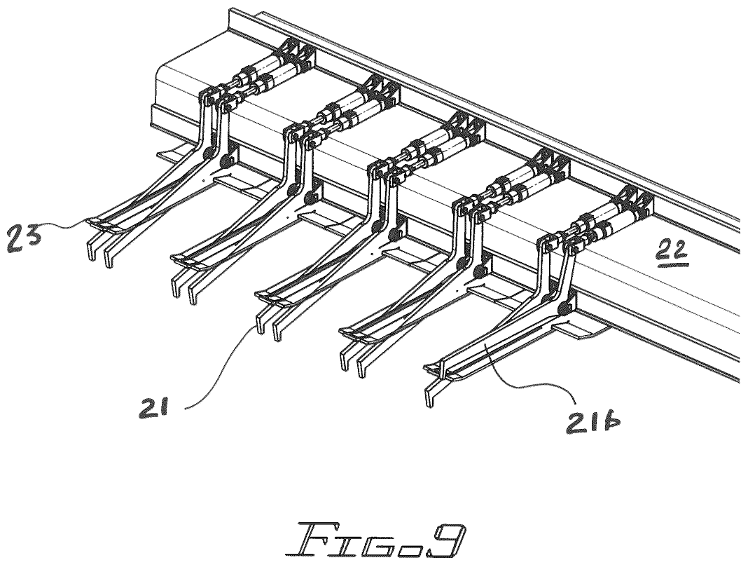

FIG. 8 shows a welding carriage 8 with fixing unit 6 in detail. The welding carriage 8 has a movable welding head, which comprises: a welding head frame 17 with a chassis 18, on which a welding force application 15 is suspended. The latter moves a welding electrode 13, which is electrically supplied via a current band 11, to the welding point SP, in particular a crossing point of a longitudinal wire LD and a transverse wire QD. A continuous welding base 12 is arranged below the welding point SP, which is not assigned to a welding carriage 8 or must be movable in the Y direction, which greatly simplifies the design of the welding unit 7.

The fixing unit 6, which is designed as a gripper element 16 as shown in FIG. 8, is also conveniently connected to the welding head frame 17. A transverse wire stop 14 is provided on the welding unit 6 for simple and safe installation of the predetermined arrangement of the longitudinal wire LD and transverse wire QD, which always moves rigidly and prevents at least one degree of freedom in the movement of the transverse wire QD (here: twisting in the X direction). In order to hold a transverse wire QD in a simple way, the transverse stops 14 are magnetic. In order to hold non-magnetizable wires, the transverse stops 14 can be designed as grippers.

A transverse wire stop 14 can be of a simple design, e.g., in the form of a sufficiently firm stop edge.

The transverse wire stop 14 and/or the fixing unit 6 can be moved out of the welding line or the area of the longitudinal wires LD on the welding head frame 17 in order to set them to the “inactive” state, which, as explained above, is necessary when moving in the Y direction and producing a special division of the wire mesh. According to the invention, the transverse wire stop 14 and/or the fixing unit 6 are moved out in the Z direction.

The method and the system can be used to produce wire mesh mats with any desired and continuously varying divisions, sizes, number of wires and wire diameters, with overhangs or even recesses in a highly variable manner. Wire mesh mats produced one after the other can vary individually or in (small) series without the changes to the system taking up any noticeable time. The example of a variation of a division explained in detail above can be repeated as often as required on a mesh mat.

FIGS. 9 and 10 show a part of a mat pull-out with a pull-out beam 22 extending essentially in the Y direction and thus parallel to welded transverse wires QD, to which a plurality of hook elements 21 are attached. The gripper elements or hook elements 21 move via carrier units 24—driven electrically, pneumatically, by spring force or hydraulically—into a lower, “active” position in which they can grip a transverse wire QD and pull it in the X direction. In this way, manufactured wire mesh mats can be pulled out step by step or completely. The latter is also used for automatic stacking of the products.

Since the longitudinal wire divisions of the wire mesh mats are highly variable according to the invention, it happens that certain hook elements 21 of the mat pull-out are prevented from gripping the transverse wire QD by a longitudinal wire LD that is currently aligned with them. To counteract this, a sufficient number of hook elements 21 are provided on the pull-out beam 22 and only those that can engage in a free mesh of the wire mesh mat are lowered into the mat level by the program control. For example, the actuators 24 can each have two hook elements 21, of which only the one or ones that are not blocked by an aligned longitudinal wire LD is or are lowered to pull out a mat.

For protection and improved effect, a guide plate 23 is also optionally provided on the pull-out beam 22, which extends slightly above the mat plane and parallel to it, and which has recesses for each hook element 21, through which they can change between the two positions “active” and “inactive”. In the upper position—passive or “inactive” (see raised hook elements 21b)—the respective hook elements 21 remain outside the area of moving parts during the manufacturing process.

Two hook elements 21 can be provided for each carrier unit 24, which are spaced apart (in the Y direction) by a distance in the order of magnitude of at least one longitudinal wire diameter, but at most that of the smallest longitudinal wire divisions, in order to securely activate only one of these hook elements 21 at a time.

In FIG. 10, the schematic wire mesh mat has four variable divisions V1, V2, V3 and V4 of the transverse wires QD and longitudinal wires LD, while the pairs of hook elements 21 are arranged in a fixed grid R analogous to the longitudinal wire guide elements 2 of the longitudinal wires LD fed in.

A mesh welding system equipped with the device according to the invention for the production of variable reinforcement mesh is therefore very flexible and without restrictions with regard to product division. There are no product configuration restrictions with regard to LD and QD divisions or different diameter combinations of the wires used. Furthermore, there are no restricted areas from the wire supply and pick-up to the product stack components. The advantages of the fully automatic system and the method for producing stepless divisions also lie in the fact that the longitudinal wire distances and transverse wire distances are variable.

### LIST OF REFERENCE NUMERALS

1 Receiving table
2 Longitudinal wire guide element
3 Longitudinal wire feed unit
4 Longitudinal wire gripper element
5 Welding portal
6 Fixing unit
7 Welding unit
8 Welding carriage
11 Current band
12 Welding base
13 Welding electrode
14 Transverse wire stop
15 Welding force application
16 Gripper element
17 Welding head frame

### 18 Chassis

21 Hook element
22 Pull-out beam
23 Guide plate
24 Carrier unit

### R Grid

V1 Variable division 1 in longitudinal direction
V2 Variable division 2 in longitudinal direction
V3 Variable division 3 in longitudinal direction or transverse
V4 Variable division 4 in longitudinal direction Longitudinal wire
QD Transverse wire
SP Welding point

What is claimed is:

1-10. (canceled)

11. A method for producing a wire mesh mat from intersecting longitudinal wires and transverse wires comprising the steps of:
(i) feeding of a set of longitudinal wires along an X direction to a welding portal with welding units, wherein the longitudinal wires are moved and held parallel to one another in a fixed grid by releasable longitudinal wire gripper elements which can move along in the X direction,
(ii) welding of at least one first longitudinal wire with a first transverse wire,
(iii) Releasing of the clamping of the at least one first longitudinal wire and moving of the non-welded longitudinal wires in the −Y direction, which is essentially perpendicular to the X direction, in order to adjust the grid of at least one longitudinal wire,
(iv) welding of at least one second longitudinal wire to the first transverse wire,
(vii) multiple, clocked feeding of the set of longitudinal wires in the X direction and simultaneous welding of all previously welded longitudinal wires with a second and further transverse wires.

12. The method according to claim 11, wherein the following steps are carried out after step (iv) and before step (vii):
(v) releasing of the clamping of the at least one second longitudinal wire and moving of the non-welded longitudinal wires in the +Y direction or in the −Y direction,
(vi) welding of at least a third longitudinal wire to the first transverse wire.

13. The method according to claim 11, wherein step (i) comprises the sub-steps of:
(i-a) removing of a set of longitudinal wires, which are held ready in a fixed grid by longitudinal wire guide elements on a receiving table, by a longitudinal wire feed unit, which can be moved towards the receiving table in the −X direction and to which the longitudinal wires are clamped in longitudinal wire gripper elements depending on the required longitudinal wire distance,
(i-b) moving of the longitudinal wire feed unit in the +X direction together with the set of longitudinal wire.

14. The method according to claim 11, comprising the further step of:
(viii) pulling out of a wire mesh mat behind the welding portal with a pull-out beam movable in the X direction, which temporarily hooks or engages with a plurality of hook elements on one of the transverse wires of a wire mesh mat.

15. The method according to claim 14, wherein only those of a plurality of hook elements are brought into action in step (viii) which, according to the produced grid, lie on the wire mesh mat between two adjacent longitudinal wires.

16. A mesh welding system for welding a wire mesh mat from intersecting longitudinal wires and transverse wires with a clocked feed device for a set of longitudinal wires in an X direction, with a feed device for transverse wires lying perpendicular to the longitudinal wires and with a welding portal for welding the wires at their intersection points, wherein a receiving table for receiving the set of longitudinal wires lying parallel to one another and with longitudinal wire guide elements is provided in a fixed grid, a longitudinal wire feed unit which can be moved back and forth cyclically in the X direction is arranged between the receiving table and the welding portal, which in turn has longitudinal wire gripper elements for the longitudinal wires, wherein the longitudinal wire feed unit can also be moved in the Y direction and wherein the distance of the welding portal from the longitudinal wire guide elements is at least dimensioned such that a longitudinal wire located therein remains deformable in the elastic range at maximum deflection.

17. The mesh welding system according to claim 16, wherein a plurality of welding units are provided in the welding portal, in front of each of which a fixing unit for a longitudinal wire is arranged as seen in the production direction X.

18. The mesh welding system according to claim 16, wherein a plurality of welding units are provided in the welding portal, on each of which a transverse wire stop is arranged.

19. The mesh welding system according to claim 16, wherein a pull-out beam, which can be moved in the X direction and extends essentially in the Y direction, is arranged downstream of the welding portal in the production direction X and has a plurality of hook elements for transporting wire mesh mats, wherein the hook elements are individually pivotable between two positions, in which the hook elements are located either outside the mesh plane or inside the mesh plane.

20. The mesh welding system according to claim 19, wherein at least one guide plate is provided on the pull-out beam, which extends at a predetermined distance above the mesh plane, and which has passages for the hook elements, through which the hook elements can be moved between the two positions.
